(19) United States
(12) Patent Application Publication
(10) Pub. No.: US 2003/0086124 A1
(43) Pub. Date: May 8, 2003

(54) Method and system for distributing facsimiles

(76) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/053,411

(22) Filed: Nov. 7, 2001

(51) Int. Cl. H04N 1/00

(52) U.S. Cl. 358/402

(57) ABSTRACT

A method and system for the distribution of facsimile transmissions is disclosed. More particularly, methods and systems for distributing facsimile transmissions to individual or multiple recipients using a facsimile distribution center for receiving facsimiles, storing facsimiles, and notifying intended recipients of a location from which a facsimile may be retrieved using the Internet, e-mail accounts, e-mail enabled printers, or e-mail enabled print servers.

### FIELD OF THE INVENTION

The present invention relates generally the distribution of facsimile transmissions. More particularly, the present invention relates to systems and methods for distributing facsimile transmissions to individual or multiple recipients using the Internet, e-mail enabled printers, embedded web server printers, e-mail enabled print servers, or web browser enabled printers.

### BACKGROUND OF THE INVENTION

Two widely used methods for personal and business communication include electronic mail and facsimile transmission. Both communication processes advantageously allow messages, documents, and images to be transmitted between remotely located senders and recipients.

Electronic mail (or “e-mail”) generally refers to messages that are electronically sent from one computer user to another over an interconnected network, such as a Local Area Network (LAN), Wide Area Network (WAN) or the Internet. Generally, e-mail provides a store-and-forward service for the transmission of data in a machine-readable format from one computer terminal, or computer system, to another. Typically, e-mail sent from one computer user (the “sender”) to another computer user (the “recipient”) is stored in the recipient's mailbox, or post office, until the recipient logs onto the system supporting e-mail delivery. The system then provides for retrieval and delivery of the message. Systems, which support e-mail services generally, further provide software for composing messages, transferring messages from the message originator to the intended recipient, notifying the recipient, reporting to the originator upon message receipt, and placing messages in the proper format for transmission over the networks.

Often, e-mail messages contain relatively small amounts of text or other forms of data in “body portions” of the e-mail. Many e-mail users, however, also send one or more additional files of data, called “attachments,” which are added, or attached, to the e-mail message. E-mail attachments may include files such as large text or word processing files, graphic files, or image files. Typically, the e-mail attachments are encoded to facilitate transmission with the e-mail. The attachments may be decoded by the recipients system.

To send an e-mail message, plus any attachments, the sending party identifies the intended recipient by a unique e-mail address used in routing the e-mail to the proper destination. The sending party then transmits the e-mail. The e-mail typically interacts via Simple Mail Transfer Protocol (“SMTP”) with an SMTP server, forwarding the e-mail message plus any attachments to the SMTP server. The SMTP server may exist locally on a network, as is the case in many office environments, or may be provided by an Internet Service Provider (ISP).

Upon receipt by the SMTP server, the address specified by the e-mail message is generally checked to determine if the recipient identified in the message is local. That is, if the recipient is a computer user directly supported by the SMTP server. If the recipient is “local,” the message is delivered to a “local” mailbox (typically a POP3 server) or other delivery mechanism where the recipient can retrieve the message. If the recipient is not local, the SMTP server determines the delivery location of the recipient's e-mail address by consulting, for example, a Domain Name Server, which provides a data table containing a list of domain names and corresponding e-mail addresses. The SMTP server uses this information to route the e-mail transmission over the Internet to a POP3 server (or an Internet message access protocol (IMAP) server) associated with the recipient.

For e-mail messages delivered locally and over the Internet, the message typically remains in the POP3 server until such time as the recipient authenticates and opens their e-mail account. Upon authentication, all of the e-mail in the recipient's account is downloaded to the recipient's computer. Once received, the recipient may perform various actions on the e-mail, such as reading, storing, replying to, deleting, or printing the e-mail.

Use of e-mail for business and personal communications has several advantages over other communication methods. Although subscriber fees may be assessed against an e-mail user, e-mail is still relatively inexpensive in that an unlimited number of messages can be sent to virtually anywhere in the world at no additional cost. Furthermore, the quality (e.g., readability) of e-mail messages is retained through the messaging process. E-mail is also fast and convenient, typically sent and received in a matter of moments. Additionally, e-mail is relatively private in that e-mail accounts are typically protected by user passwords. Finally, sent and received e-mail may easily be tracked by e-mail software, which may incorporate notification failed message attempts, return receipts and other notifications.

While e-mail offers quick and easy communication between computer users, there is relatively little e-mail interaction occurring between linked devices other than computers (i.e., computer workstations).

Traditional facsimile (“fax”) machines (e.g., fax machines conforming to the Group 3 Standard) operate by measuring and recording the light and dark areas (in the form of pixels) on a hard copy of a document with an optical scanner. These light and dark areas are processed into a binary image file and then compressed for transmission by one of a variety of source encoding techniques using source compression algorithms. The digital representation of the document image may be transmitted over the public switched telephone network (“PSTN”) using a voice-band modem, the modem converting the digital files into analog signals capable of traveling over phone lines. At the receiving end, a modem associated with a receiving fax machine reconverts the analog signal into a digital file, whereupon the digital file is decompressed into the original binary file format. The receiving fax machine translates the binary file into an image, which can be printed by the receiving fax machine.

Alternatively, a computer may operate as a “fax machine” by employing special translation software that converts a document from and to a facsimile transmission format. Using a modem and the PSTN for transmission, users at properly configured computers can send and receive facsimile images.

With respect to conventional fax machines (and computer-based faxing), the receiving machine may be unavailable if turned off or if the telephone line to which it is attached is busy. Additionally, images may be garbled or otherwise corrupted in transmission by telephone line problems or by paper jams in the receiving fax machine. Also, long distance connections between transmitting fax machines often require expensive communication charges. Finally, many users only have limited access to fax machines, as many households do not have a fax machine and many businesses typically only have a single fax machine. Thus, facsimile transmission between conventional fax machines is not optimized in terms of accuracy of message transmission and convenience of use.

In a further hybrid of conventional e-mail and fax techniques, a large number of companies now provide fax-to-e-mail or e-mail-to-fax services. Persons subscribing to such services are typically provided with a unique telephone number and an e-mail account, which serve as proxies for receiving and sending faxes. The telephone number may be a local phone number, a long distance number, a 1-800 number, or the like, which may be published or otherwise provided by a subscriber to the service. Using the fax-to-e-mail service, a conventional dial-up fax machine (e.g., a Group 3 fax machine) may send analog transmissions through the PSTN to the subscriber's unique phone number associated with the service. Upon receipt of the fax transmission at the service, the fax transmission is converted to a digital file, compressed (usually to a Tag(ged) Image File Format (“TIFF”) file), and associated with the subscriber's e-mail address as an attachment to a service-generated e-mail. The resulting e-mail is then automatically forwarded over the Internet, typically via an SMTP protocol, directly to the subscriber's e-mail inbox. The subscriber may then retrieve the e-mail like any other e-mail message on the subscriber's computer workstation. To open the retrieved e-mail and view the contents, an image viewer compatible with the format of the transmitted file is required.

An exemplary fax-to-e-mail system for receiving and viewing fax transmissions on a computer workstation is described in U.S. Pat. No. 6,020,980 to Freeman, the disclosure of which is hereby incorporated herein in its entirety.

### SUMMARY OF THE INVENTION

The present invention relates generally the distribution of facsimile transmissions. More particularly, the present invention relates to systems and methods for distributing facsimile transmissions to individual or multiple recipients using the Internet, e-mail enabled printers, embedded web server printers, e-mail enabled print servers, or web browser enabled printers.

One embodiment of the present invention involves the distribution of a facsimile to multiple users through the Internet. A facsimile sent to a specified phone number or e-mail address associated with a facsimile distribution center is received and saved to a storage media that may be accessed in the future. Typically, a unique Uniform Resource Locator (URL) is associated with the storage location for the facsimile. Based upon the phone number or e-mail address to which the facsimile was sent, the facsimile distribution center determines the intended recipients of the facsimile. This is accomplished by retrieving recipient contact information from a database where a recipient's contact information is associated with the phone number or e-mail address to which the facsimile was sent. The facsimile distribution center then notifies the intended recipients of the facsimile by sending a facsimile to the recipients using the recipient contact information. Typically, the body of the facsimile sent to the intended recipients identifies the URL where the facsimile is stored so that each recipient may retrieve the facsimile by logging onto the URL via the Internet.

Alternatively, the facsimile distribution center may inform the recipient of the facsimile stored at the specified URL through e-mail. Accessing a database of email addresses and associated phone numbers, the e-mail addresses of the intended recipients are ascertained by the association with the facsimile phone number. Using the e-mail addresses, the facsimile distribution center notifies the intended recipients of the presence of the facsimile stored at a specified URL.

In another embodiment of the present invention, the facsimile distribution center communicates the URL for a stored facsimile to an embedded web server printer or web browser enabled printer. Using the URL, the embedded web server printer or web browser enabled printer connects to an Internet connection, or other communication connection, to access the URL specified by the facsimile distribution center. Once connected with the designated URL, the embedded web server printer or web browser enabled printer retrieves the identified facsimile from the storage location identified by the URL. The embedded web server printer or web browser enabled printer may then store, forward, or print the facsimile.

### DESCRIPTION OF THE DRAWINGS

While the specification concludes with claims particularly pointing out and distinctly claiming that which is regarded as the present invention, the present invention can be more readily ascertained from the detailed description of the invention when read in conjunction with the accompanying drawings in which:

FIG. 1 illustrates possible components for a facsimile distribution system of the present invention;

FIG. 2 illustrates a representative portion of a table of data stored for use with the facsimile distribution system of the present invention; and

FIG. 3 illustrates a block diagram of the process steps that may be used with the present invention.

### DETAILED DESCRIPTION OF THE INVENTION

The present invention relates generally the distribution of facsimile transmissions. More particularly, the present invention relates to systems and methods for distributing facsimile transmissions to individual or multiple recipients using the Internet, e-mail enabled printers, embedded web server printers, e-mail enabled print servers, or web browser enabled printers.

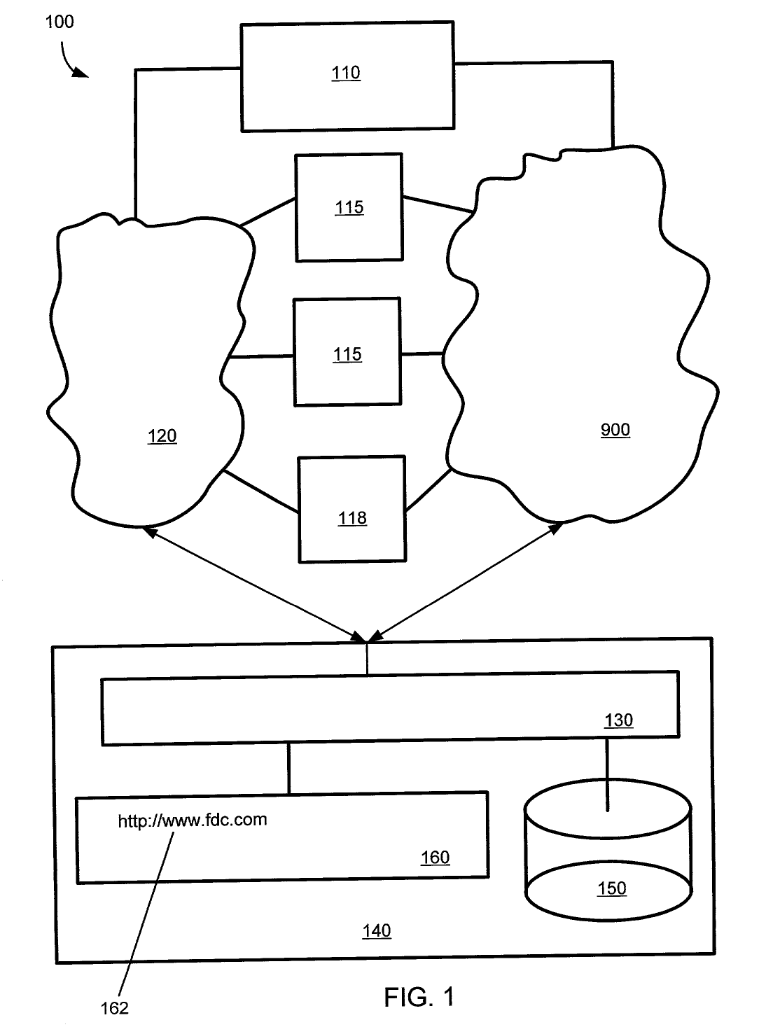

In one embodiment of the present invention, a facsimile sent to a phone number associated with a facsimile distribution center is stored and the intended recipients are notified of the facsimile, which they may retrieve from a designated Uniform Resource Locator (URL). In another embodiment of the present invention, an Internet enabled device is notified of the storage location of a facsimile and the Internet enabled device automatically retrieves the stored facsimile for an intended recipient. Each embodiment of the present invention may be better understood with reference to FIGS. 1 through 3.

A simplified version of exemplary architecture that may be used with the facsimile distribution methods of the present invention is illustrated in FIG. 1. A facsimile distribution system 100 comprises an originating facsimile machine 110 capable of sending facsimiles over a public or private telephone network 120 to a specified telephone or modem number associated with a facsimile distribution center 130. Alternatively, a facsimile may be sent via Internet 900. Typically, the facsimile distribution center 130 is an executable computer program or programs residing on a computer 140 such as a network server. A database 150 may be associated with, or accessible to, the facsimile distribution center 130 for identifying intended recipients of facsimiles received by the facsimile distribution center 130. Storage media 160 may also be available to the facsimile distribution center 130 and may be associated with computer 140. Additional facsimile machines 115 may be accessible to the facsimile distribution center 130 through the public or private telephone network 120, an intranet, or Internet 900. Similarly, Internet enabled devices 118, such as embedded web server printers or web browser enabled printers, may be accessible to the facsimile distribution center 130 through public or private telephone networks 120, intranets, or the Internet 900.

Originating facsimile machine 110, as well as facsimile machines 115, may be any type of facsimile machine as known in the art, including conventional facsimile machines (e.g. Group 3 Standard), computer software facsimile machines, or Internet facsimile machines. At least originating facsimile machine 110 includes the capability for sending facsimiles. This may include the ability to scan a document hardcopy, process the scanned document image into a binary file, and compress the scanned image for facsimile transmission. Facsimile machines 115 at least include the capability to receive a facsimile transmission and convert the facsimile transmission to a hardcopy document.

Internet enabled devices 118 may include embedded web server printers, web browser enabled printers and the like. Typically, Internet enabled devices 118 may be capable of receiving scripting or programming codes and operating with those codes to perform certain tasks, such as downloading information from an identified Internet 900 storage location.

The public or private telephone network 120 is not unique. Transmission of facsimiles over public telephone lines is well known and further explanation thereof is omitted for brevity. It is understood that the facsimile transmissions referred to in describing the present invention include conventional, well-known technologies for sending and receiving facsimiles.

Computer 140 may include any type of computing platform capable of receiving and sending facsimiles. Typically, computer 140 is a server type computer associated with a network of computers. However, computer 140 may be a facsimile machine capable of executing the computer programs associated with the facsimile distribution center 130 and accessing database 150 and storage media 160. Preferably, computer 140 may be equipped to handle multiple incoming telephone lines, may be able to distinguish between multiple numbers for receiving incoming facsimiles, and may be capable of handling Internet 900 communications.

In the illustrated embodiment of the facsimile distribution system 100, computer 140 is depicted as hosting the facsimile distribution center 130, database 150, and storage media 160. It is understood that database 150 and storage media 160 may be remote to computer 140. For example, database 150 and storage media 160 may be stored on a second computer accessible to computer 140. It is also understood that although database 150 is illustrated as a separate component of the facsimile distribution system 100, database 150 may be incorporated within the facsimile distribution center 130 programming.

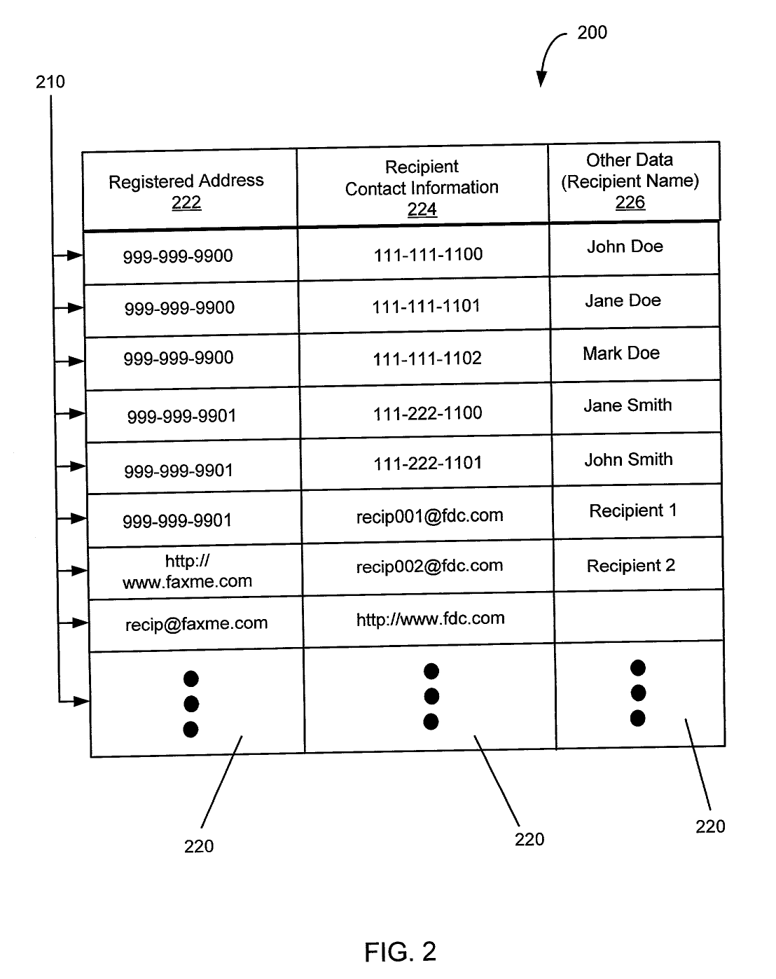

Database 150 may store information pertinent to the facsimile distribution center 130. Specifically, database 150 may include tables, records and fields associating facsimile numbers with intended facsimile recipients. For instance, a graphical depiction of a portion of a representative table 200 from database 150 is illustrated in FIG. 2. Each record 210 in table 200 includes fields 220 for storing data used by the facsimile distribution center 130. Fields 220 may include data about registered address 222, recipient contact information 224, or other data 226, such as recipient names, as needed by the facsimile distribution center 130. As illustrated, registered number 999-999-9900 is associated with recipient contact information 111-111-1100, 111-111-1101, and 111-111-1102, which represent facsimile numbers. Similarly, registered number 999-999-9901 is associated with facsimile numbers 111-222-1100, 111-222-1101, and e-mail address “recip001@fdc.com” as stored in the recipient contact information 224 data fields 220. In this example, other data 226 includes the names of the recipients associated with the recipient contact information. Although registered address values may appear in multiple records 210, it is understood that other data formats may be used such that a single instance (e.g. a primary key or unique field) of a registered address 222 may be associated with a set of recipient contact information 224 stored in a single record and delimited by a ASCII character such as a comma or semicolon. Furthermore, additional data records 210 and fields 220 may be stored in database 150.

The storage of registered addresses 222 may also include URL addresses or e-mail addresses for receiving facsimiles. Similarly, the recipient contact information 224 may include URL addresses or e-mail addresses for notification of facsimile delivery. For instance, a URL address, “www.faxme.com,” stored as a registered address 222, may be associated with an e-mail address, “recip002@fdc.com,” stored as recipient contact information 224 in database 150.

Storage media 160 may include memory, hard disks, compact discs, floppy disks, optical discs, or other storage media generally associated with data storage. Preferably, storage media 160 is associated with one or more URL addresses 162 that may be accessed using the Internet. Such storage capabilities are well known in the art.

Facsimile distribution center 130 typically comprises an executable program or hardwired program for receiving facsimiles, sending facsimiles, and/or performing various other computing tasks. The facsimile distribution center 130 may monitor multiple incoming phone lines, facsimile lines, or Internet 900 connections to detect any incoming facsimiles. Similar to facsimile programs available for personal computers, the facsimile distribution center 130 automatically receives any incoming facsimiles. Generally, the facsimile distribution center 130 receives a facsimile addressed to a registered address 222, or other contact, determines the intended recipients for the facsimile from database 150, stores the facsimile on storage media 160, and sends facsimile messages to the intended recipients, based on the recipient contact information 224, to inform them of the presence of a facsimile at a designated URL address. The intended recipient may then retrieve the facsimile from the URL address.

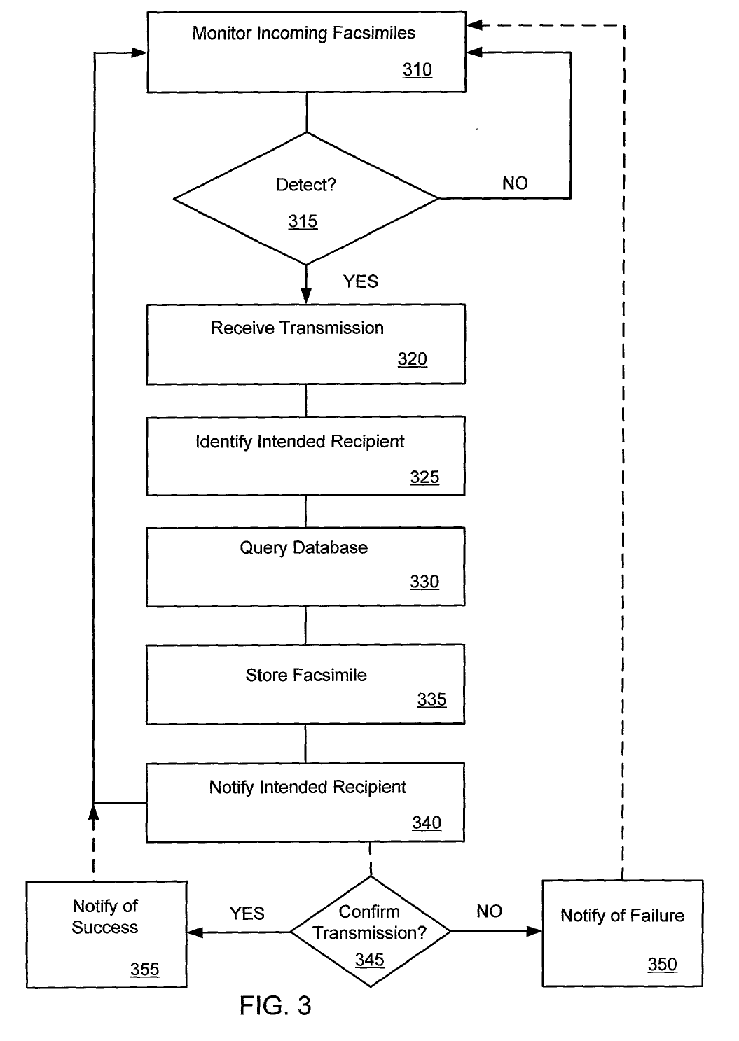

The process steps undertaken by the facsimile distribution center 130 are further detailed in the block diagram of FIG. 3. The facsimile distribution center 130 monitors 310 incoming facsimile lines, or Internet 900 connections, for any transmission activity. If an incoming facsimile is detected 315 the facsimile distribution center 130 receives 320 the transmission. If no incoming facsimiles are detected 315, the facsimile distribution center 130 continues to monitor 310 for incoming facsimiles. Upon receiving 320 a facsimile, the facsimile distribution center 130 identifies 325 the intended recipient of the transmission. The facsimile distribution center 130 queries 330 database 150 for all of the intended recipients associated with the number or address to which the facsimile was sent. The facsimile distribution center 130 stores 335 the received facsimile to storage media 160. The facsimile is stored in a unique directory on the storage media 160. The name of the directory to which the facsimile is stored or saved is used by the facsimile distribution center 130 to create a URL address or path identifier for identifying the location of the stored facsimile. Although the step of querying 330 the database 150 is shown occurring before the step of storing 335 the facsimile in FIG. 3, it is understood that these steps may be reversed or performed virtually simultaneously. The facsimile distribution center 130 notifies 340 the intended recipients by contacting each of the numbers or addresses stored in the recipient contact information 224 fields in database 150 that are associated with the number or address to which the original facsimile was sent. Once the intended recipients are notified 340, such as by facsimile, e-mail, or other communications, the facsimile distribution center 130 returns to monitoring 310 incoming telephone and facsimile lines for transmissions.

Optionally, the facsimile distribution center 130 may attempt to confirm 345 transmissions of the facsimiles to the intended recipients. If confirmations from each intended recipient are received, a confirmation may be sent 355 to the originating facsimile machine 110 that sent the original facsimile to the facsimile distribution center 130. Likewise, if confirmations of successful transmissions are not received from each intended recipient, the facsimile distribution center 130 may notify the originating facsimile machine 110 of the delivery failure 350.

The notifications 340 sent by the facsimile distribution center 130 to the intended recipients identify a URL address or location where a facsimile is stored. Upon receiving the identifying notification, an intended recipient may access the specified URL address to download the facsimile. For example, an intended recipient may access the designated URL address through the Internet 900, through an intranet, or over a network system, depending upon where the facsimile distribution center 130 stored the facsimile.

In addition, the designated URL address may include security features such that an intended recipient must enter a user name and password to retrieve the facsimile stored at the specific URL address. Pre-set user names and passwords may be stored in database 150 and stored with the facsimile on storage media 160. If an attempt is made to access the URL address without the proper security identification, access is denied.

One embodiment of the facsimile distribution system 100 of the present invention is demonstrated in the following example: A company having multiple employees—John Doe, Jane Doe, and Mark Doe—working in remote locations, wishes to send each of the employees a large, multiple page facsimile. To reduce long distance communications costs and to limit the amount of time the company facsimile machine is in operation, the company registers with a facsimile distribution service. In doing so, the company is provided with a facsimile number, or registered address 222, to which they can send facsimiles intended for their employees. The company also provides the recipient contact information 224 for each of its employees to the facsimile distribution service. This information is stored in a database 150 associated with the facsimile distribution system 100. The first three records 210 of data table 200 in FIG. 2 are representative of the manner in which the data is stored in database 150.

To make a facsimile available to John, Jane, and Mark, the company sends the facsimile to the facsimile distribution center 130 using their associated registered address 222, in this case 999-999-9900. The facsimile distribution center 130 detects the incoming facsimile and receives the transmission. The facsimile distribution center 130 identifies the registered number 222 as 999-999-9900 and queries a database 150 for the intended recipient contact information 224. The numbers 111-111-1100, 111-111-1101, and 111-111-1102 are returned to the facsimile distribution center 130. In addition, the recipient names associated with the recipient contact information 224 are also returned. The facsimile distribution center 130 then stores the facsimile, in computer readable format, on storage media 160. Storage media 160 is associated with an Internet home page having a URL address of “http://www.fdc.com”. The facsimile is stored in a directory associated with the URL address “http://www.fdc.com/companyX/facsimile”.

The facsimile distribution center 130 then prepares separate facsimiles for notifying each of the intended recipients of the stored facsimile. The recipients name may be identified on the respective facsimiles along with a message indicating that they may view and/or download a facsimile stored at the URL address “http://www.fdc.com/companyX/facsimile.” Facsimiles are then sent by the facsimile distribution center 130 to the intended recipients using the numbers from the recipient contact information 224. Once confirmation of successful transmission is complete, the facsimile distribution center 130 sends a confirmation facsimile back to the originating facsimile machine at the company.

In the above example, the company may deliver a multi-paged facsimile to multiple individuals or groups using a single transmission of the facsimile. In situations where multiple facsimile recipients are desired and where the facsimiles are large, use of the facsimile distribution system 100 of the present invention saves considerable amounts of time and money, including long-distance charges and facsimile operation time.

Another embodiment of the present invention is very similar to the facsimile distribution system 100 previously described. In this embodiment, a facsimile informing the recipient of the existence of a facsimile at a specific URL address is not used. Instead, an e-mail informs the intended recipients of the presence of a facsimile at a designated URL address. The facsimile distribution center determines an e-mail address associated with the intended recipients from the recipient contact information 224 stored in database 150. For example, the e-mail address “recip001@fdc.com” associated with registered address 222, 999-999-9901, in FIG. 2, may be used as recipient contact information 224. Using the recipient e-mail address, the facsimile distribution center composes an e-mail message for each recipient indicating that they may view and/or download their facsimile from the designated URL address at which the facsimile distribution center has saved the facsimile. Thus, an intended recipient is informed of the presence of a facsimile addressed to them.

In yet another embodiment of the present invention, an Internet enabled device 118, such as an embedded web server printer or a web browser enabled printer, may automatically retrieve a facsimile stored at a specified URL address. In this embodiment of the present invention, a facsimile is sent from a facsimile machine 110 to a facsimile distribution center 130 as previously described. The facsimile distribution center 130 determines the recipient contact information 224 based upon the address or number to which the facsimile was sent. The facsimile distribution center 130 constructs a message to send to an Internet enabled device 118 identified by the recipient contact information 224. Typically, the constructed message may consist of an e-mail including script codes for instructing the Internet enabled device 118 to perform certain functions or actions. Generally, the message may also invoke an action to be performed by the identified device, such as automatically retrieving a facsimile from a specified URL address and printing the facsimile.

This embodiment of the present invention may be more readily understood with reference to an example. A facsimile machine 110 sends a facsimile to the URL address “www.faxme.com” associated with a facsimile distribution center 130. The facsimile distribution center 130 receives the facsimile and accesses a database 150 to determine the intended recipient or recipients of the facsimile from the recipient contact information 224 stored in database 150. As illustrated in FIG. 2, the recipient contact information 224 indicates that the registered address 222 “www.faxme.com” is associated with a recipient having an e-mail address “recip002@fdc.com.” The facsimile distribution center 130 is able to determine that the intended recipient of the facsimile is an e-mail address, thus, an informative e-mail may be prepared to notify the intended recipient of the facsimile.

The facsimile distribution center 130 stores the received facsimile at a specified URL address on storage media 160, for example, at the URL address “http://www.fdc001.com/facsimile001.” An e-mail identifying the URL address may be prepared by the facsimile distribution center 130 for delivery to the e-mail address of the intended recipient. In this embodiment of the present invention, an e-mail is prepared that includes scripts, or other programming code, for enabling the recipient Internet enabled device 118 to locate the stored facsimile. The prepared e-mail will, of course, include the URL address of the stored facsimile, in this case “http://www.fdc001.com/facsimile001.” Once prepared, the e-mail is sent to the intended device.

An Internet enabled device 118, such as an embedded web server printer or a web browser enabled printer, receiving an e-mail from the facsimile distribution center 130 with the included scripting, or other programming codes, may strip the URL address of the stored facsimile from the e-mail. The programming codes may also instruct the Internet enabled device 118 to retrieve the facsimile. When instructed to do so, the Internet enabled device 118 connects to the Internet 900 and seeks out the storage location of the facsimile, “http://www.fdc001.com/facsimile001.” Once found, the Internet enabled device 118 preferably downloads the facsimile to a memory of the Internet enabled device 118 for printing. Alternatively, the Internet enabled device 118 may download and directly print the stored facsimile. In this manner, a facsimile received and stored by a facsimile distribution center 130 may be automatically retrieved by an Internet enabled device 118, such as an embedded web server printer or a web browser enabled printer.

Having thus described certain preferred embodiments of the present invention, it is to be understood that the invention defined by the appended claims is not to be limited by particular details set forth in the above description, as many apparent variations thereof are possible without departing from the spirit or scope thereof as hereinafter claimed.

What is claimed is:

1. A method of distributing a facsimile to an Internet enabled device, comprising:
receiving a facsimile;
storing said facsimile on a storage media at a specific location;
identifying an Internet enabled device associated with each intended recipient of said facsimile; and
notifying each identified Internet enabled device of said specific location for said saved facsimile

2. The method of claim 1, wherein said notifying each identified Internet enabled device of said specific location for said saved facsimile comprises sending said Internet enabled device an e-mail identifying said specific location for said saved facsimile.

3. The method of claim 1, further comprising:
using said Internet enabled device to retrieve said saved facsimile from said specific location; and
printing said facsimile.

4. The method of claim 1, wherein said Internet enabled device is selected from the group consisting of an embedded web server printer and a web browser enabled printer.

5. A method of distributing a facsimile, comprising:
sending a facsimile to a registered address;
retrieving said facsimile;
determining a set of intended recipients for said facsimile from said registered address;
saving said facsimile with to a specific storage location on a storage media; and
notifying each of said set of intended recipients of said saved facsimile and said specific storage location for retrieving said facsimile.

6. The method of claim 5, wherein said registered address is associated with a facsimile distribution center.

7. The method of claim 6, wherein said facsimile distribution center comprises a computer program for receiving facsimiles, saving facsimiles, sending facsimiles, sending e-mails, and determining intended recipients for saved facsimiles.

8. The method of claim 5, wherein said registered address is selected from the group consisting of phone numbers, e-mail addresses and uniform resource locator addresses.

9. The method of claim 5, wherein determining a set of intended recipients from said registered address comprises querying a database for determining a set of intended recipients.

10. The method of claim 9, wherein querying a database for determining a set of intended recipients comprises querying said database with said registered address to determine at least one recipient contact information address associated with said registered address.

11. The method of claim 10, wherein said recipient contact information address is selected from the group consisting of phone numbers, e-mail addresses, and uniform resource locator addresses.

12. The method of claim 10, wherein querying a database for determining a set of intended recipients further comprises querying said database with said registered address to determine at least one recipient name associated with said registered address.

13. The method of claim 5, wherein saving said facsimile with to a specific storage location on a storage media, comprises:
saving said facsimile to a storage media associated with a uniform resource locator address; and
assigning a unique path name to said saved facsimile.

14. The method of claim 5, wherein notifying each of said set of intended recipients of said saved facsimile and said specific storage location for retrieving said facsimile comprises sending each of said set of intended recipients a facsimile identifying the specific storage location of the saved facsimile.

15. The method of claim 5, wherein notifying each of said set of intended recipients of said saved facsimile and said specific storage location for retrieving said facsimile comprises sending each of said set of intended recipients an e-mail identifying the specific storage location of the saved facsimile.

16. The method of claim 5, wherein notifying each of said set of intended recipients of said saved facsimile and said specific storage location for retrieving said facsimile, comprises:
notifying an Internet enabled device of said specific storage location for retrieving said facsimile; and
activating said Internet enabled device to retrieve said facsimile from said specific storage location.

17. The method of claim 16, further comprising, printing said facsimile at said Internet enabled device.

18. A system for distributing facsimiles, comprising:
a facsimile distribution center for receiving facsimiles, saving facsimiles, and sending notification messages;
a storage media for storing facsimiles saved by said facsimile distribution center; and
a database for determining intended recipients for received facsimiles.

19. The system of claim 18, wherein said facsimile distribution center comprises at least one computer program for receiving facsimiles, accessing said database to determine at least one intended recipient of said facsimile, and notifying said at least one intended recipient of said facsimile by a method selected from the group consisting of e-mail and facsimile.

20. The system of claim 18, wherein said facsimile distribution center comprises:
at least one computer program for receiving facsimiles, saving facsimiles, and sending notification messages; and
at least one communications port for communicating with the Internet or a phone line.
